(19) United States
(12) Patent Application Publication
(10) Pub. No.: US 2025/0068728 A1
(43) Pub. Date: Feb. 27, 2025

(54) METHOD FOR SAFEGUARDING A VEHICLE WITH VEHICLE SECURITY TECHNOLOGY

(71) Applicant: Robert Bosch GmbH, Stuttgart (DE)

(72) Inventors: Carsten Nobbe, Remchingen (DE); Joachim Graf, Gueglingen (DE); Lars Vogel, Ludwigsburg (DE); Lukas Jung, Stuttgart (DE); Michael Schwab, Korntal-Muenchingen (DE)

(21) Appl. No.: 18/782,243

(22) Filed: Jul. 24, 2024

(30) Foreign Application Priority Data
Aug. 25, 2023 (DE) 10 2023 208 139.3

(51) Int. Cl. G06F 21/55

(52) U.S. Cl. CPC G06F 21/554; G06F 2221/034

(57) ABSTRACT

A method for safeguarding a vehicle with vehicle security technology. A computer program, a device, and a storage medium for this purpose are also described.

### CROSS REFERENCE

The present application claims the benefit under 35 U.S.C. § 119 of German Patent Application No. DE 10 2023 208 139.3 filed on Aug. 25, 2023, which is expressly incorporated herein by reference in its entirety.

### FIELD

The present invention relates to a method for safeguarding a vehicle with information technology. The present invention furthermore relates to a computer program, a device, and a storage medium for this purpose.

### BACKGROUND INFORMATION

In the field of IT security, in particular host-based and network-based solutions are available, which, however, do not take into account personal safety, for example. Furthermore, often only services for detection are prevalent, for example, or only basic prevention of IT security risks, which are moreover only performed offline, for example, and not during vehicle operation. It can also often happen that preventive mechanisms for a detected security risk are not yet available, so that the detected security risk remains until an update and, for example, a vehicle cannot be used until the detected security risk is eliminated. In the related art, a detection (IDS) is in particular followed by a response (IPS) that appears possible from an attack security perspective and necessary at that point in time. However, especially in the automotive context, it may be necessary to consider not only attack security but also personal safety and, where appropriate, also further non-functional properties, such as availability or reliability.

Within the scope of the present invention, personal safety preferably relates to the prevention of personal injury, while attack security relates to the prevention of attacks on a vehicle, in particular attacks on the software and hardware of the vehicle.

### SUMMARY

The present invention is a method, a computer program, a device, and a computer-readable storage medium. Further features of and details relating to the present invention can be found in the disclosure herein. Features and details which are described in connection with the method according to the present invention of course also apply in connection with the computer program according to the present invention, the device according to the present invention, and the computer-readable storage medium according to the present invention, and respectively vice versa, so that, with respect to the disclosure, mutual reference is or can be made to the individual aspects of the present invention at all times.

The present invention relates in particular to a method for safeguarding a vehicle with vehicle security technology.

According to an example embodiment of the present invention, the method comprises the following steps:
Detecting an attack on the vehicle via a detection module, wherein the detection module provides a description of the attack,
Evaluating the description of the attack via a decision module, wherein the decision module assesses at least one measure against the attack on the basis of a personal safety requirement and an attack security requirement, wherein the personal safety requirement represents a safety of at least one occupant of the vehicle or at least one road user and the attack security requirement represents a security against attacks on the vehicle, in order to provide instructions for implementing the at least one measure on the basis of the assessment,
Implementing the at least one measure on the basis of the provided instructions via an implementation module, wherein the implementation module coordinates the provided instructions.

The personal safety requirement may for example be a specification or a set of rules, which is formulated with respect to the safety of the at least one occupant of the vehicle or at least one road user. In simple terms, this can ensure that the vehicle can continue to operate or drive in such a way that the at least one occupant or the at least one road user is not endangered, for example by an accident. The at least one road user may for example be a pedestrian or a driver of another vehicle. Furthermore, personal safety can also relate to aspects such as reliability and/or availability of the vehicle, since these aspects can also affect the at least one occupant or the at least one road user. The reliability of a technical product or system in general is in particular a property that specifies how reliably a function assigned to the product or system is fulfilled in a time interval. The availability of a technical system in general is in particular the probability or extent that the system fulfills certain requirements at a certain point in time or within an agreed time frame. The attack security requirement may also be for example a specification or a set of rules, which is, however, formulated with respect to the security against attacks on the vehicle. Financial, legal or data-protection-related aspects may also be taken into account, for example. The combination of attack security and personal safety can be referred to as vehicle security, whereby safeguarding this combination in particular provides the safeguarding of the vehicle with vehicle technology. The attacks may be of an information technology or electronic nature, such as hacking attacks. Measures include, for example, deactivating a process on an attacked system or reconfiguring a firewall. The instructions may include one or more of the measures and may also for example specify a goal of the measure and/or a time requirement for implementing the measure. The implementation module can advantageously send feedback to the decision module, for example after a measure has been implemented. The method, which comprises at least the preceding steps, can be advantageous for considering both attack security, i.e., security, and personal safety, i.e., safety, in an automotive context. Furthermore, during a function (e.g., autonomous driving), a possible measure that considers these goals can advantageously be found and implemented. The detection module and/or the decision module and/or the implementation module can advantageously retrieve information from a vehicle state or send information to a vehicle state. The vehicle state can be considered as a black box that encapsulates relevant status information. Time-critical information can be exchanged via a direct feedback loop, which is available between the decision module and implementation module functional groups. Furthermore, the detection module and/or the decision module and/or the implementation module can advantageously have a connection to a vehicle security operations center (VSOC). The VSOC is preferably a backend service that can receive information about potential attacks from the detection module functional group, information about triggered preventive measures from the decision module functional group, and information about successfully performed preventive measures from the implementation module functional group. In the VSOC, information from all vehicles in a fleet can be processed (for example even manually by security experts).

It can be advantageous if, within the scope of the present invention, the detecting furthermore comprises the following step:
Monitoring the vehicle using at least one sensor, wherein the at least one sensor registers at least events in the vehicle, wherein the events are specific to a possible presence of the attack on the vehicle.

According to an example embodiment of the present invention, the at least one sensor can be attached to an element of the vehicle architecture, where the at least one sensor can take measurements of an environment of the vehicle or of the vehicle itself, in particular of at least one functionally relevant part of the vehicle. Exemplary capabilities of the at least one sensor may be accessing protocols, triggering the at least one sensor through hooks or triggers, or reading network traffic of the vehicle. The at least one sensor can also capture various status information of the vehicle. On the basis of the events and status information, the at least one sensor can advantageously collect numerous data which are relevant to detecting and describing the attack.

It is also possible that the detecting furthermore comprises the following step:
Filtering the registered events in order to provide a selection of the registered events as qualified events, wherein the qualified events are determined by a filter by using at least one defined criterion, wherein the at least one defined criterion is specific to the possible presence of the attack on the vehicle.

The at least one criterion can be a collection of events or status information, which may be known from expert knowledge or past executions of the method. It is also possible that an event must exceed a defined threshold value or occur a defined number of times in order to be provided as a qualified event by the filter. The filter can thus advantageously make a pre-selection in order to reduce the amount of data transmitted for further calculation and thus, for example, to increase computing power. As a result, a real-time application can advantageously be provided.

According to an example embodiment of the present invention, it is also optionally possible that the detecting furthermore comprises the following step:
Analyzing the events, in particular the qualified events, via a recognition module in order to classify the event, in particular the qualified event, as an attack via the recognition module on the basis of at least one defined attack signature and/or a deviation from an expected behavior.

According to an example embodiment of the present invention, the recognition module can use various pattern recognition techniques, for which a machine learning model can be used. The recognition module can advantageously determine precisely whether there is a high probability that an attack on the vehicle is present which requires measures to be performed.

According to an example embodiment of the present invention, it may furthermore be possible for the evaluating to furthermore comprise at least one of the following steps:
Providing or assessing the at least one measure via an attack security controller of the decision module, wherein the attack security controller provides or assesses the at least one measure on the basis of the description of the attack while taking into account the attack security requirement,
Providing or assessing the at least one measure via a personal safety controller of the decision module, wherein the personal safety controller provides or assesses the at least one measure on the basis of the description of the attack while taking into account the personal safety requirement.

By separately providing and/or assessing the at least one measure via the attack security controller and the personal safety controller, it is advantageously possible to improve the individual consideration of the attack security requirement and the personal safety requirement. Within the scope of the present invention, a “controller” can be designed, for example, as a software module.

A further advantage within the scope of the present invention can be achieved if the evaluating furthermore comprises the following step:
Providing the instructions for implementing the at least one measure via a mediator module of the decision module, wherein the mediator module communicates with the attack security controller and the personal safety controller in order to provide the instructions while taking into account the attack security requirement and the personal safety requirement.

In simple terms, the mediator module can advantageously take on a mediation function in order to take into account both the requirements of the attack security controller and the requirements of the personal safety controller. It may be provided that the requirements of the personal safety controller have priority and are subordinated to the requirements of the attack security controller only in exceptional cases. A plurality of iterations of communication by the mediator module between the attack security controller and the personal safety controller can be provided in order to find an optimal solution through the at least one measure.

A further advantage within the scope of the present invention can be achieved if the implementing furthermore comprises the following step:
Monitoring and coordinating the provided instructions via a response controller of the implementation module, wherein the response controller is connected to at least one actuator in order to implement the measure with the at least one actuator.

According to an example embodiment of the present invention, the response controller can monitor and coordinate the implementation of the instructions and can plan and coordinate individual actions of the actuators. The response controller can ensure that potential preconditions (e.g., with respect to the vehicle state) for a measure are fulfilled. The at least one actuator is in particular responsible for the implementation of the individual parts of the measures. Alternatively, the measure can be implemented by a plurality of distributed actuators.

Exemplary measures that are implemented by the at least one actuator are terminating a process, changing firewall configurations, intentionally or deliberately degrading a function, restoring or ensuring a function. It can be provided that the response controller and/or the at least one actuator are designed to send feedback. The feedback from the at least one actuator can be sent to the response controller after the at least one measure has been implemented. The response controller can furthermore send the feedback from the actuator or further feedback to the decision module after the at least one measure has been implemented.

The vehicle may, for example, be designed as a motor vehicle and/or passenger vehicle and/or autonomous vehicle. The vehicle can comprise a vehicle device, for example for providing an autonomous driving function and/or a driver assistance system. The vehicle device can be designed to at least partially automatically control and/or accelerate and/or brake and/or steer the vehicle.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for data processing that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be carried out as a computer-implemented method.

Further advantages, features and details of the present invention can be found in the following description, in which exemplary embodiments of the present invention are described in detail with reference to the figures. The features disclosed herein can be essential to the present invention, individually or in any combination.

### BRIEF DESCRIPTION OF THE DRAWINGS

FIG. 1 is a schematic visualization of a method, a vehicle, a device, a storage medium and a computer program according to exemplary embodiments of the present invention.

FIG. 2 is a schematic representation of an intrusion detection and prevention system (IDPS) according to exemplary embodiments of the present invention.

FIG. 3 is a schematic representation of a process flow for preventing attacks according to an exemplary embodiment of the present invention.

### DETAILED DESCRIPTION OF EXAMPLE EMBODIMENTS

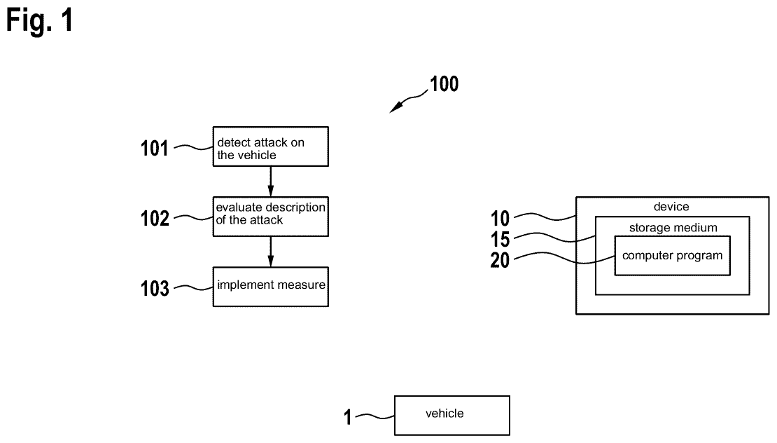

FIG. 1 schematically shows a method 100, a vehicle 1, a device 10, a storage medium 15 and a computer program 20 according to exemplary embodiments of the present invention.

According to the exemplary embodiment in FIG. 1, the method 100 for safeguarding a vehicle 1 with information technology comprises a first method step 101, in which an attack on the vehicle 1 is detected by a detection module 5. The detection module 5 provides a description 17 of the attack. In a second method step 102, the description 17 of the attack is evaluated by a decision module 8. The decision module 8 assesses at least one measure against the attack on the basis of personal safety and attack security. Personal safety represents the safety of at least one occupant of the vehicle 1 or at least one road user, and attack security represents the security against attacks on the vehicle 1. On the basis of the assessment, instructions are provided for implementing the at least one measure. In a third method step 103, the at least one measure is implemented by an implementation module 13 on the basis of the provided instructions, wherein the implementation module 13 coordinates the provided instructions.

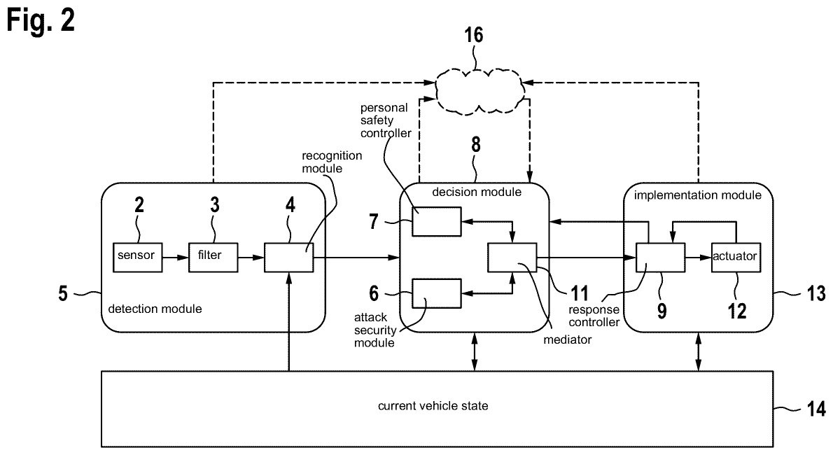

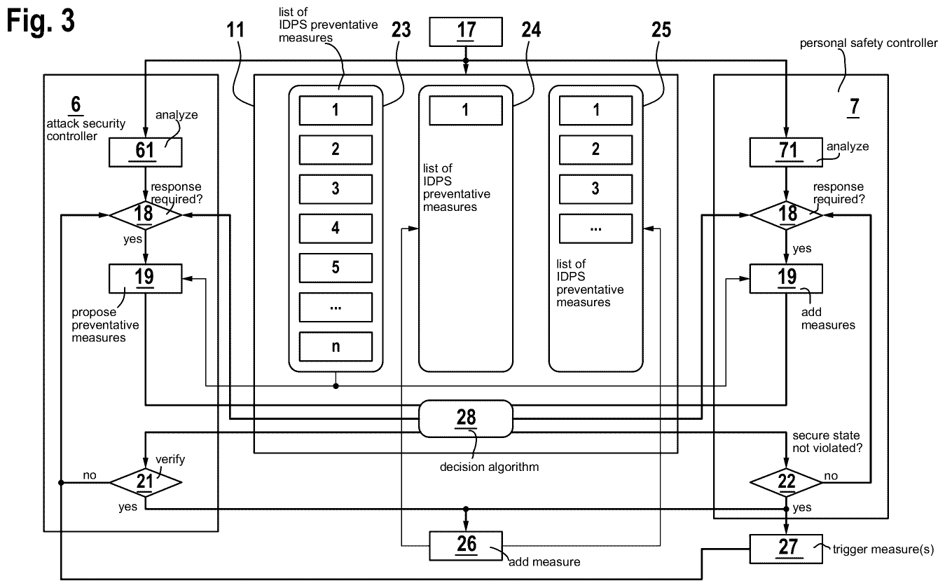

The following description refers in particular, at least in part, to the exemplary embodiments of FIGS. 2 and 3.

Within the scope of the present invention, an in-vehicle IDPS is in particular logically divided into three blocks, which can be further divided into individual logical components, as shown in FIG. 2. It should be noted that this graphic preferably shows only the logical connections and functional dependencies and does not impose any restrictions on the number or location of the individual components or functional elements. In a specific IDPS instantiation of this function chain, a single logical component can occur in a plurality of (distributed) instances, and the functionality of a plurality of logical components can be covered by a single component. The functional element can be connected differently in a plurality of distributions and can be distributed to different vehicle architectures.

The detection module 5 functional group can observe, process and analyze events in order to determine whether the system is under attack. When an attack is recognized, an attack report is preferably created, which can correspond to a description 17 of the attack. The description 17 of the attack could also provide information about the security or a probability of potential attacks, e.g., for self-learning systems. The detection module 5 functional group can be divided into the following functional elements:

The sensor 2 functional element preferably registers not only all events that could contain an indicator of compromise (IoC), i.e., events that could indicate a potential compromise or an intervention, but also other relevant status information. The sensor 2 can observe or monitor the system. Its task is in particular to collect and transmit the event information.

The filter 3 functional element preferably processes events from one or more sensors and determines whether the event can be considered as an IoC and should be forwarded. The filter 3 preferably performs a pre-selection of events that are relevant to this decision (i.e., minimizing the information transmission and the processing load). A filter 3 can also forward status information from sensors that is not necessarily regarded as an IoC but contains relevant information required by a recognition module 4 to determine whether the system is under attack. The term “qualified events” can be used for events processed by the filter 3. (Note: Since the sensor 2 collects events in an unfiltered manner, the filter 3 is in particular responsible for discarding irrelevant events, which can reduce the amount of information that needs to be transmitted and processed in the following steps).

The recognition module 4 functional element preferably processes qualified events from one or more filters 3 and, if applicable, the current vehicle state 14 and can determine whether these observations are to be classified as an attack. Various recognition methods, which are generally based on matching with known attack signatures (signature-based) or on recognizing deviations from expected behavior (anomaly-based), can be used for this classification. If the recognition module 4 determines that the system, i.e., in particular the vehicle 1, is under attack, it preferably creates a description 17 of the attack with the attack details. For example, in its input, the recognition module 4 receives events reporting an attempted access to a restricted resource and decides to classify this as an attack. The recognition module 4 can subsequently compile a description 17 of the attack, which contains information about the affected resource and the responsible process.

If IDS solutions, which are possibly provided by third parties, are already present in the vehicle 1, they can be integrated into the IDPS architecture. It can be assumed that such a solution behaves like a black box that outputs information as soon as it recognizes an attack. With the help of an adapter, this information can then be converted into an input that the recognition module 4 understands.

The decision module 8 functional group preferably receives a description 17 of an attack from the detection module 5 functional group, checks the current vehicle state 14 if applicable, and decides whether a response is necessary. If a response is necessary, the IDPS preventive measure(s) can be selected and checked for their respective attack security capabilities and personal safety capabilities. In some cases, the optimal IDPS preventive measure can be selected from the attack security perspective and verified from the personal safety perspective. If this verification fails in at least one respect, alternative IDPS preventive measures may be chosen that achieve the prevention goal in a different way, if possible. It may also be the case that such a preventive measure is not found and a pre-existing measure from the (vehicle 1 or control unit) safety concept can be implemented. This can also be the case if a time restriction must be adhered to, e.g., the fault-tolerant time interval (FTTI) relevant to personal safety. Such a response in particular consists of a combination of IDPS preventive measures implemented in a particular order. These selected measures are then preferably forwarded in the form of a detailed sequence of instructions to the response controller 9, which in turn provides feedback on the IDPS preventive measures implemented.

The decision module 8 functional group can be divided for example into the following functional elements, which can reach an agreement on the measure to be taken:

The attack security controller 6 functional element preferably has the task of deciding which IDPS preventive measure(s) to choose from the attack security perspective, i.e., which steps are most effective in order to stop the attack and limit its consequences. An example would be that the attack security controller 6 decides to deactivate the architectural element (e.g., external communication) from which the attack originates.

The personal safety controller 7 functional element can ensure that the IDPS preventive measure does not endanger the safety of the vehicle 1, i.e., in particular personal safety. It can also propose preventive measures, e.g., from the existing safety concept. In this way, the personal safety controller 7 in particular decides and checks which IDPS preventive measures form a safe context for use, and can ultimately also block certain measures if the requirements are not fulfilled. If the attack requires a fast safety response (i.e., in particular, compliance with the FTTI safety requirement), the personal safety controller 7 can trigger a preventive measure as a priority, i.e., from the existing safety concept. An example would be that, assuming that the deactivation of the architectural element violates the safety concept, the personal safety controller 7 finds the accompanying or alternative steps (i.e., IDPS preventive measures) to keep the vehicle 1 in a safe state while the architectural element is deactivated as requested by the personal safety controller 7, if this is ultimately possible.

The mediator 11 of the functional element can coordinate communication between the entities responsible for personal safety and attack security and is in particular responsible for the final decision on the proposed preventive measure. Within the scope of the present invention, the mediator 11 is also referred to synonymously as a mediator module. The mediator 11 also preferably compiles a list of IDPS preventive measures, possibly a plurality of possible lists in parallel, wherein the mediator 11 complies with the restriction, in particular from the point of view of the security schedule. In this case, the mediator 11 can also forward parts of the list to the implementation module 13 and also take into account the feedback thereof.

The implementation module 13 functional group is preferably responsible for implementing the IDPS preventive measures decided upon by the decision module 8 functional group. The implementation module 13 functional group can also provide feedback if the implementation is delayed or not possible at all for any reason. Status feedback on the progress of the implementation could also be helpful for the decision module 8.

The functional group can be divided into the following functional elements:

The response controller 9 functional element in particular receives the sequence of instructions and can be responsible for the coordination and scheduling of the individual steps of the IDPS preventive measures with the actuators. The response controller 9 ensures, preferably while taking into account the vehicle state 14, that each measure is implemented only if given preconditions from the decision are fulfilled. In addition, the response controller 9 preferably provides feedback on performed measures to the detection module 5 functional group. An example would be that if the measures consist of a plurality of steps that depend on one another and must be implemented in a certain order, the response controller 9 can monitor the implementation of the individual steps and coordinate the actions of the actuators accordingly.

The actuator 12 functional element preferably receives individual instructions for the preventive measure, implements these instructions accordingly and provides the response controller 9 with feedback on the implementation. An example would be that an actuator 12 can be instructed to terminate a process or reconfigure the firewall settings, i.e., blacklist the IP address.

In addition to the functional groups and elements of the function chain of the in-vehicle IDPS, FIG. 2 in particular also shows a connection to the vehicle state 14. The vehicle state 14 can be considered as a black box that encapsulates status information relevant to the IDPS system. However, all time-critical information can be exchanged via direct feedback loops that are available between the decision module 8 and implementation module 13 functional groups. The vehicle state 14 can also be used to synchronize a plurality of instances of the IDPS function chains, in particular if the focus is on different aspects, e.g., the vehicle function perspective, which is to be taken into account within an IDPS chain on a vehicle architecture element and vice versa. Examples in this respect include: current driving situation, actuator status, security states, firewall configurations, diagnostic modes, software/firmware versions.

FIG. 2 in particular also shows the connection to the vehicle security operations center (VSOC 16): The VSOC 16 is preferably a backend service that can receive information about potential attacks from the detection module 5 functional group, information about triggered preventive measures from the decision module 8 functional group, and information about successfully performed preventive measures from the implementation module 13 functional group. In the VSOC 16, information from all vehicles 1 in a fleet can be processed (for example even manually by security experts). If the analysis reveals an attack that requires a fleet-wide response, the VSOC 16 can send corresponding instructions to the decision module 8 functional group of the individual vehicles 1. In particular, the VSOC 16 is not a main component of the in-vehicle IDPS function chain, but an element of an IDPS in the fleet-wide context.

In practice, it is possible for a single component to take on the task of a plurality of logical components. An example would be that, in a network-based IDPS, a sensor 2 could observe all network traffic. Instead of duplicating all traffic and forwarding it to a filter 3, it can be useful to combine the sensor 2 with a filter 3 in order to reduce the number of forwarded messages.

In addition, there can be a plurality of instances of a single component in an IDPS, either as a supplement because the architecture is distributed to various physical (or virtual) components, or in order to create redundancy.

If solutions for individual functional elements or functional groups of the function chain already exist (e.g., standalone IDS solutions for AutoSAR or Linux), they can be integrated by means of user-defined adapter elements that make an interface to other functional elements or groups of the function chain possible.

As regards the input, the sensor 2 is preferably attached to an element of the vehicle architecture where it can observe the environment. In particular, no further explicit inputs will be made. An output of the sensor 2 can be an event resulting from the observations made by the sensor 2. The sensor 2 reports its observations for example in a particular format. The sensor 2 may be influenced by its observations. The sensor 2 may be stateless and not take into account the state of the vehicle 1. The sensor 2 preferably observes the activities on an element of the vehicle architecture and collects information. The sensor 2 generates events that can be further processed by filters 3 or recognition modules 4. Exemplary capabilities of the sensor 2 may be accessing protocols, triggering the sensor 2 through hooks or triggers, or reading the network traffic.

An input of the filter 3 can be an event reported by a sensor 2. An output can be a qualified event. For each received event, the filter 3 can decide whether it can be considered as an IoC or as relevant status information that is required by the recognition module 4 and therefore should be forwarded as a qualified event, on the basis of the inputs from a plurality of sensors where appropriate. Otherwise, the event will not be forwarded, for example if it is deemed irrelevant (i.e., not as an IoC). The filter 3 may be state-dependent (i.e., it maintains a local state that may influence its decision) but is preferably not dependent on the vehicle state 14. The filter 3 could also provide a reliability assessment based on self-learning algorithms. The filter 3 preferably identifies the IoCs and other status information in the input and forwards only the relevant ones as an output. This pre-selection can significantly reduce the number of qualified events that are forwarded to the recognition module 4 for further analysis. Exemplary capabilities include receiving static sensor inputs. It can be provided that events are only forwarded as qualified events if a threshold value (e.g., n=10) is reached. This advantageously reduces the data traffic to the recognition module 4 (e.g., to 10%).

An input of the recognition module 4 can be a qualified event from a sensor 2. An output can be a description 17 of the attack, which contains detailed information about the attack (including affected architectural elements, involved sensors and filters 3, optionally a confidence level). The recognition module 4 can use a combination of different recognition methods to determine whether the observed system is under attack and, if so, to derive additional information. Each recognition method can use (parts of) the inputs, the local state of the recognition module 4, and/or the vehicle state 14. Each description 17 of the attack is output together with all relevant details about the attack, which can also include a confidence level, in order to make the decision as early as possible. The recognition module 4 in particular determines whether the observed system is under attack. If an attack is determined, the recognition module 4 preferably creates a description 17 of the attack which contains all relevant details about the attack. Exemplary capabilities in particular include using various techniques (e.g., pattern recognition, outlier/anomaly recognition, artificial intelligence) to recognize attacks in the received inputs.

An input of the attack security controller 6 can be a description 17 of the attack, a message from the mediator 11 (optionally the vehicle state 14 and the VSOC 16), and/or feedback from the response controller 9. An output can be a message to the mediator 11 (optionally the vehicle state 14 and the VSOC 16). In case of a reported attack, the attack security controller 6 preferably uses the information obtained from the descriptions 17 of the attack, and optionally the vehicle state 14 and the VSOC 16, as a basis for deciding on appropriate IDPS preventive measures. The attack security controller 6 can communicate with the mediator 11, which in turn can communicate with the personal safety controller 7. Preferably, the attack security controller 6 can route an IDPS preventive measure to the implementation module 13 not independently but only via the mediator 11 in order to verify personal safety.

The attack security controller 6 preferably decides which IDPS preventive measures (from the attack security perspective) should be taken in order to mitigate a reported attack and achieve a secure state. The attack security controller 6 can do this in coordination with the mediator 11 (i.e., maintain a secure state) and repeat or alternate the IDPS preventive measures if necessary. Exemplary capabilities include deactivating a process on an attacked system, reconfiguring a firewall (e.g., blacklist), or triggering a sequence of individual measures.

An input of the personal safety controller 7 can be a description 17 of the attack, a message from the mediator 11 (optionally the vehicle state 14 and the VSOC 16), feedback from the response controller 9, an output communication to the mediator 11 (optionally the vehicle state 14 and the VSOC 16). Before an IDPS preventive measure is triggered in response to an attack, the personal safety controller 7 may be consulted by the mediator 11 and may propose alternative or additional preventive measures for safety reasons. The personal safety controller 7 bases its decision for example on the inputs of the mediator 11 and optionally the vehicle state 14 and the VSOC 16. However, the personal safety controller 7 can preferably make a final decision not autonomously but in coordination with the mediator 11, which in turn coordinates with the attack security controller 6. The personal safety controller 7 is in particular responsible for ensuring a safe state with respect to the occupants of the vehicle 1 and preferably does not allow any IDPS preventive measures that violate the safety of the vehicle 1, in particular with respect to occupants of the vehicle 1. If a reported attack requires a time-critical IDPS preventive measure, the personal safety controller 7 can propose appropriate preventive measures to the mediator 11, which said mediator must trigger within the specified time, provided that this is possible under personal safety aspects. The personal safety controller 7 preferably has the task of ensuring that the safety of the vehicle 1 is not violated by the IDPS preventive measures, i.e., in particular that occupants of the vehicle 1 are protected, for example from an accident. In addition, the personal safety controller 7 can take measures to enforce and/or restore the safety of the vehicle 1, or personal safety, if it is violated by an attack. An exemplary capability is a proposal of a sequence of accompanying IDPS preventive measures in order to ensure personal safety, in particular if the IDPS preventive measures are time-critical (i.e., FTTI).

An input of the mediator 11, which can also be referred to synonymously as a mediator module 11 within the scope of the present invention, can be a description 17 of the attack, a message from the attack security controller 6 or the personal safety controller 7 (optionally the vehicle state 14 and the VSOC 16), or feedback from the response controller 9. An output can be a message to the attack security controller 6 and the personal safety controller 7 (optionally the vehicle state 14 and the VSOC 16), a sequence of instructions for the response controller 9. When a description 17 of the attack is received, the mediator 11 can communicate with the attack security controller 6 and the personal safety controller 7 to coordinate the IDPS preventive measure(s), if possible. On the basis of this communication, the mediator 11 can send a corresponding sequence of instructions to the response controller 9. If the personal safety controller 7 requires the implementation of an IDPS preventive measure within a certain time interval, the mediator 11 must preferably fulfill this request and forward it to the implementation module 13 as quickly as possible. The mediator 11 in particular communicates with the attack security controller 6 and the personal safety controller 7 and can collect possible sequences of instructions that it can forward to the response controller 9. Exemplary capabilities include collecting the communication between attack security controller 6 and personal safety controller 7 until a sequence of appropriate measures is defined (or a temporary solution is prioritized due to time constraints, e.g., FTTI), and outputting the corresponding instructions.

An input of the implementation module 13 can be a sequence of instructions for implementing the IDPS preventive measures (optionally the vehicle state 14). An output can comprise instructions for the actuators, feedback to the functional group for prevention instructions (optionally the vehicle state 14 and the VSOC 16). The response controller 9 can monitor and coordinate the implementation of the received IDPS prevention instructions. The response controller 9 can plan and coordinate the actions of the actuators. The response controller 9 can ensure that all potential preconditions (e.g., with respect to the vehicle state 14) for an IDPS preventive measure are fulfilled. As soon as the sequence of instructions has been triggered, it can be completely resolved, or feedback on an interruption can be provided to the decision module 8, in order to solve the problem. The response controller 9 is in particular responsible for coordinating the performance of the IDPS preventive measures.

Exemplary capabilities include triggering the implementation of a step of the IDPS preventive measure only after completion of the preceding step, triggering and coordinating the implementation of IDPS preventive measures (if possible in parallel).

An input of the actuator 12 can be an instruction to perform IDPS preventive measures. An output can be feedback to the response controller 9 (optionally the vehicle state 14 and the VSOC 16). The actuator 12 preferably implements the received instruction and can provide the response controller 9 with feedback on the completion or cancellation of the action. The actuator 12 is in particular responsible for performing the individual “smallest parts” of the IDPS preventive measures. Exemplary capabilities include terminating a process, changing firewall configurations, compromising a function, restoring or ensuring a function.

The vehicle 1 must preferably always be in a secure state. A crucial point for an in-vehicle IDPS can therefore be the impact on and thus the interaction between personal safety and attack security. While both areas may ultimately have the goal of ensuring a safe, no-compromise experience for the road users, attack security is in particular concerned with protecting the vehicle 1 from any kind of malicious damage, and personal safety is in particular concerned with preventing any kind of personal injury. Although it may generally be in the interest of personal safety to prevent attacks on a vehicle 1, there may be cases in which the best response measure for IDPS prevention, from an attack security perspective, cannot be safely performed immediately, such as turning off critical and/or autonomous vehicle functions to mitigate an attack while driving at high speed, and additional IDPS preventive measures are therefore required to achieve a secure state with respect to personal safety. On the other hand, there may be cases in which personal-safety-oriented IDPS preventive measures can compromise attack security, for example by opening a backup communication channel to a compromised architectural element that has been intentionally isolated. That is to say, there are in particular trade-offs between personal safety and attack security which preferably must be made very carefully within the respective scope of application while taking into account all constraints, which can lead to a list of IDPS preventive measures which are ultimately implemented.

The attack security controller 6 functional element preferably tracks the current attack security state of the vehicle 1 and can ensure that the IDPS preventive measures used keep the system in a secure state with respect to attack security in case of an attack.

The personal safety controller 7 functional element tracks the current personal-safety-related state of the vehicle 1 and can trigger IDPS preventive measures in order to ensure that the vehicle 1 remains in a secure state with respect to personal safety. The personal safety controller 7 can thus propose IDPS preventive measures in order to create a context in which the IDPS preventive measures can be safely used.

Ideally, appropriate (i.e., safe) IDPS preventive measures can be statically determined for certain attack scenarios and vehicle states so that the coordination between personal safety states and attack security states via the respective control units becomes trivial and corresponding IDPS preventive measures can be triggered.

If this simple solution is not possible, the measures to prevent or frustrate attacks can be ascertained and defined dynamically. The two entities responsible for processing must negotiate (in a manner moderated and supervised by the mediator 11) which mechanisms will be used to prevent or frustrate intruders or attacks.

One possibility for the process flow in the decision module 8 functional group is shown in FIG. 3. The decision module 8 functional group and thus all functional elements of this group preferably receive the description 17 of the attack from the detection module 5, which initiates the decision process. The attack security controller 6 and the personal safety controller 7 each analyze 61, 71 the description 17 of the attack. If a response is required 18 (which can always be the case after a possible attack), the attack security controller 6 can propose 19 an appropriate IDPS preventive measure, which can be verified by the personal safety controller 7 in order to ensure that the secure state with respect to personal safety is not violated 22 by the implementation of the chosen measure. If the IDPS preventive measure cannot be safely implemented in the current vehicle state 14, the personal safety controller 7 can add personal-safety-related IDPS preventive measures 19 in order to enable the implementation of the IDPS preventive measure, if possible. These additional personal-safety-related IDPS preventive measures can in turn be verified by the attack security controller 6 in order to ensure that the vehicle-secure state is not further violated 21. However, such a violation could be tolerated if additional IDPS preventive measures are subsequently added to restore a vehicle-secure state. This iteration, i.e., the checking by the personal safety controller 7, can be repeated until there are no more violations of the personal-safe and vehicle-secure states. As soon as such an agreement exists, the IDPS preventive measure(s) (or parts of this list) can be triggered 27.

Furthermore, the middle of FIG. 3 shows the mediator 11, which has a plurality of lists of IDPS preventive measures 23, 24, 25. Said lists can be produced through the iterative communication between the attack security controller 6 and personal safety controller 7, wherein a measure is in particular added 26 to a list 23, 24, 25 after each check as to whether a vehicle-secure and personal-safe state is ensured. Part of the mediator 11 can be a decision algorithm 28.

If agreement cannot be reached in this way, the IDPS preventive measure can preferably not be triggered. Such a case may also be reported to the VSOC 16 in order to analyze why no viable solution to mitigate the attack could be found on the basis of the report received.

If a time-critical response is required, the personal safety controller 7 can trigger such an IDPS preventive measure via the mediator 11 with the required priority.

The above description of the embodiments describes the present invention exclusively in the context of examples. Of course, individual features of the embodiments, provided they make technical sense, can be freely combined with one another without departing from the scope of the present invention.

What is claimed is:

1. A method for safeguarding a vehicle with vehicle security technology, comprising the following steps:
detecting an attack on the vehicle via a detection module, wherein the detection module provides a description of the attack;
evaluating the description of the attack via a decision module, wherein the decision module assesses at least one measure against the attack based on a personal safety requirement and an attack security requirement, wherein the personal safety requirement represents a safety of at least one occupant of the vehicle or at least one road user, and the attack security requirement represents a security against attacks on the vehicle, in order to provide instructions for implementing the at least one measure based on the assessment; and
implementing, via an implementation module, the at least one measure based on the provided instructions, wherein the implementation module coordinates the provided instructions.

2. The method according to claim 1, wherein the detecting includes the following step:
monitoring the vehicle using at least one sensor, wherein the at least one sensor registers at least events in the vehicle, wherein the events are specific to a possible presence of the attack on the vehicle.

3. The method according to claim 2, wherein the detecting further includes the following step:
filtering the registered events to provide a selection of the registered events as qualified events, wherein the qualified events are determined by a filter by using at least one defined criterion, wherein the at least one defined criterion is specific to the possible presence of the attack on the vehicle.

4. The method according to claim 3, wherein the detecting further includes the following step:
analyzing the qualified events, via a recognition module, in order to classify each qualified event as an attack via the recognition module based on at least one defined attack signature and/or a deviation from an expected behavior.

5. The method according to claim 1, wherein the evaluating includes at least one of the following steps:
providing or assessing the at least one measure via an attack security controller of the decision module, wherein the attack security controller provides or assesses the at least one measure based on the description of the attack while taking into account the attack security requirement;
providing or assessing the at least one measure via a personal safety controller of the decision module, wherein the personal safety controller provides or assesses the at least one measure based on the description of the attack while taking into account the personal safety requirement.

6. The method according to claim 5, wherein the evaluating further includes the following step:
providing the instructions for implementing the at least one measure via a mediator module of the decision module, wherein the mediator module communicates with the attack security controller and the personal safety controller to provide the instructions while taking into account the attack security requirement and the personal safety requirement.

7. The method according to claim 1, wherein the implementing includes the following step:
monitoring and coordinating the provided instructions via a response controller of the implementation module, wherein the response controller is connected to at least one actuator in order to implement the measure with the at least one actuator.

8. A device for data processing for safeguarding a vehicle with vehicle security technology, the device configured to:
detect an attack on the vehicle via a detection module, wherein the detection module provides a description of the attack;
evaluate the description of the attack via a decision module, wherein the decision module assesses at least one measure against the attack based on a personal safety requirement and an attack security requirement, wherein the personal safety requirement represents a safety of at least one occupant of the vehicle or at least one road user, and the attack security requirement represents a security against attacks on the vehicle, in order to provide instructions for implementing the at least one measure based on the assessment; and
implement, via an implementation module, the at least one measure based on the provided instructions, wherein the implementation module coordinates the provided instructions.

9. A non-tangible computer-readable storage medium on which is stored commands for safeguarding a vehicle with vehicle security technology, the commands, when executed by a computer, causing the computer to perform the following steps:
detecting an attack on the vehicle via a detection module, wherein the detection module provides a description of the attack;
evaluating the description of the attack via a decision module, wherein the decision module assesses at least one measure against the attack based on a personal safety requirement and an attack security requirement, wherein the personal safety requirement represents a safety of at least one occupant of the vehicle or at least one road user, and the attack security requirement represents a security against attacks on the vehicle, in order to provide instructions for implementing the at least one measure based on the assessment; and
implementing, via an implementation module, the at least one measure based on the provided instructions, wherein the implementation module coordinates the provided instructions.
